(19) United States
(12) Patent Application Publication
(10) Pub. No.: US 2016/0088129 A1
(43) Pub. Date: Mar. 24, 2016

(54) Electronic Apparatus and Method of Making Electronic Apparatus

(71) Applicant: Lenovo (Beijing) Co., Ltd., Beijing (CN)

(72) Inventors: Chenghao Zhang, Haidian District (CN); Beiou Luan, Haidian District (CN)

(73) Assignee: Lenovo (Beijing) Co., Ltd., Beijing (CN)

(21) Appl. No.: 14/640,716

(22) Filed: Mar. 6, 2015

(30) Foreign Application Priority Data
Sep. 19, 2014 (CN) 201410483719.5

(51) Int. Cl. H04M 1/02; B21D 22/02; C25D 11/04; C25D 11/34; B22D 17/00; C25D 11/02

(52) U.S. Cl. CPC H04M 1/0202; B22D 17/00; C25D 11/022; C25D 11/04; C25D 11/34; B21D 22/02

(57) ABSTRACT

An electronic apparatus is described that includes a housing including a first portion made of a first material and a second portion made of a second material, and the second material is formed by transforming the first material. A method of making the electronic apparatus is also described.

### This application claims priority to Chinese patent application No. 201410483719.5 filed on Sep. 19, 2014 the entire contents of which are incorporated herein by reference.

### BACKGROUND

This disclosure relates to field of electronic technique, and particularly relates to an electronic apparatus and a method of making electronic apparatus.

At present, in order to satisfy people's requirements for intensity, tactile sensation of an appearance or the like of a housing of an apparatus, housings of most electronic devices use metal or alloy material. Since transmission of wireless signal is implemented by conducting electromagnetic wave, when the electromagnetic wave reaches a surface of a metallic housing, due to discontinuity of resistance of an interface between air and metal, the electromagnetic wave is easy to destroy formation of an electric field due to short circuit action of electro-conductive metal when it penetrates the metallic housing to propagate outwards, and disappearance of the electric field cause a magnetic field not to be generated continuously, so as to intercept continue propagation of the electromagnetic wave. Therefore, attenuation of the electromagnetic wave caused by the housing of metallic material is relatively severe.

A solution is punching or cropping at an emitting region corresponding to antenna signal on the metallic housing and filling the cropped part with non-metal material at the same time of using the metallic material as the housing of the electronic apparatus, so as to make the electromagnetic wave to pass through non-metal region punched or filled to emit to outside. Though it can transmit the signal well, since punching and cropping influence an overall strength of the housing and tend to generate destruction at a junction which influences usability thereof, and a trace of a junction of mosaic and splice may need to be further eliminated, which increases complexity and cost of the production.

To sum up, the housing of the electronic apparatus influences the transmission of the signal significantly and effect of transmission of the electronic apparatus is poor.

### SUMMARY

It is provided an electronic apparatus, comprising: a housing comprising a first portion and a second portion; the first portion being made of a first material; the second portion being made of a second material which is transformed from the first material.

Further, the housing is made of the first material and the second material.

Further, the second portion allows a higher throughput rate of an electromagnetic wave to pass through than the first portion.

And, the electronic apparatus further comprising an antenna arranged with respect to the second portion of the housing.

Further, the first material is a conductive material and the second material is a non-conductive material, and the second material is transformed from the first material through any one of a physical process, a chemical process, an electric process, or a combined process thereof.

Further, the conductive material is a metal and the non-conductive material is a metal oxide.

It is also provided a method of making an electronic apparatus, the method comprising: forming a housing of the electronic apparatus using a first material; and transforming a portion of the housing from the first material into a second material.

Further, the forming of the housing comprises: a plate stamping, a compression casting or a metal injecting of the first material.

Further, the transforming of the portion of the housing from the first material into the second material comprises: electrochemically transforming the portion of the housing using an acid solution.

And, the method further comprising: isolating a region of the housing not corresponding to the portion of the housing using a first protective film to prevent the region of the housing from transforming from the first material into the second material.

Further, the isolating of the region of the housing comprises spraying an isolation ink on a surface of the region of the housing.

### BRIEF DESCRIPTION OF THE DRAWINGS

In order to describe the embodiments of the present disclosure or the technical solutions in the related art more clearly, hereinafter, the accompany drawings necessary to be used in the description of the embodiments will be introduced briefly. Apparently, the accompany drawings in the following description are only some embodiments of the present disclosure.

FIG. 1 is a diagram of a primary structure of an electronic apparatus of the embodiments;

FIG. 2A is a schematic cross section diagram of a -housing in the embodiments;

FIG. 2B is a schematic cross section diagram of a housing in the embodiments;

FIG. 3 is a diagram of a primary flow of a method of making an electronic apparatus in the embodiments;

FIG. 4 is a schematic diagram of a passing-through effect of electromagnetic signal in the embodiments.

### DETAILED DESCRIPTION

The embodiments disclose an electronic apparatus including: a housing comprising a first portion and a second portion; the first portion being made of a first material; the second portion being made of a second material which is transformed from the first material

That is, the electronic apparatus at least including: a housing including a first portion made of a first material and a second portion made of a second material. And, the housing is made of the first material and the second material.

In the embodiments of this disclosure, since the housing of the electronic apparatus includes the first portion and the second portion, and the second material corresponding to the second portion is transformed from the first material corresponding to the first portion, the housing is made to be able to have two kinds of different and correlated materials at the same time of keeping integration of structure to make an overall strength well, so as to improve a throughput rate of wireless signal. For example, when the first material is metal, the second material may be a non-metal material obtained by transforming the metal, so that there is no need to punch or crop the housing, thus, at the time of using the electronic apparatus to transmit the wireless signal, electromagnetic wave can transmit through the second portion well, so as to reduce a shield influence of the housing to the wireless signal and improves efficiency of transmission of signal of the electronic apparatus.

At the same time, since the first portion and the second portion are an integrated structure, a junction region is integrated, there is no need to execute further processing, which simplifies a producing procedure of the housing and reduces cost.

In order to make the purpose, the technical solution and the advantage of the embodiments of this disclosure more clear and understandable, the technical solutions in the embodiments are described clearly and integrated in combination with accompanying drawings in the embodiments of this disclosure as follows. It is obvious that the described embodiments are only a part of embodiments of this disclosure instead of all embodiments. All of the other embodiments obtained by those skilled in the art without inventive labor based on embodiments in this disclosure belong to a scope sought for protection of this disclosure.

In the embodiments, the electronic apparatus is different electronic apparatus such as a PC (a personal computer), a notebook computer, a PAD (a tablet computer), a mobile phone, and this disclosure do not make any limitation thereto.

Further, terms “and/or” in the context is only an association relationship describing associated objects, which means there are three kinds of relationships. For example, A and/or B may represent three cases of only A, both A and B, and only B. Further, character “/” in the context generally represents that back and forth associated objects is in a relationship of “or”.

Hereinafter, the embodiments of this disclosure are described detailed in combination with accompanying drawings.

Firstly, with reference to FIG. 1, the embodiments provide an electronic apparatus at least including a housing including a first portion 11 and a second portion 12.

In the embodiments, the housing is a housing portion of the electronic apparatus, the housing mainly functions for protecting respective internal components of the electronic apparatus, and secondly, the housing can increase esthetics of an appearance of the electronic apparatus to a certain degree. Therefore, in a procedure of producing the electronic apparatus, people more and more pays attention to a material of the housing portion of the electronic apparatus.

In practice, the electronic apparatus includes a main body other than the housing, the main body includes a processor, a heat radiator component, a signal transmitting source, a display unit or the like, and the housing is a protective housing attached on outer surface of the main body. For example, it may be a housing of the mobile phone, a protective housing of the notebook computer or the like. Generally, the housing needs to have a shape matched with the main body so as to protect and decorate the electronic apparatus better.

At present, a material for producing the housing is mostly two kinds of a plastic material and a metallic material. Wherein, the plastic material mainly has three kinds of a PC, an ABS and PC+ABS, which are used in production of the housing of the mobile phone or the tablet computer. In models of apparatus mostly with the metallic material, a general major element is aluminum with small amount of magnesium or other metallic material doped to enhance hardness thereof. Wherein, a magnesium aluminum alloy is used considerable in a model of ultrathin apparatus due to light weight and easy heat radiation. For example, a material of a top cover of a screen is the magnesium aluminum alloy doped with magnesium, and a bottom case is titanium alloy.

In the embodiments, the first material is a conductive material and the second material is a non-conductive material, and the second material is transformed from the first material through any one of a physical process, a chemical process, an electric process, or a combined process thereof. In particular, a first material corresponding to the first portion 11 of the housing is a conductive material, i.e., a material having a lot of charged particles which move freely in an action of an electric field so as to conduct a current well. A second material corresponding to the second portion 12 is formed by executing a transforming processing to the first material, that is, the second portion 12 is a non-conducting material. Wherein, the transforming processing is any one of a physical processing manner, a chemical processing manner or an electric processing manner or a combined processing manner thereof.

Optionally, in the embodiments, the conductive material is a metallic conductive material of which a resistivity is (1.5−10)×10 ohm. Main functions of the metallic conductive material are broadly used for electromagnetic shielding, producing electrodes, electro-heat material, housing of apparatus or the like in addition to transmitting electric power and electrical signal, and a general metallic conductive material is classified as metallic element, alloy (copper alloy, aluminum alloy or the like), composite metal or the like. Wherein, the metallic elements include silver, copper, gold, aluminum or the like; the alloy includes aluminum magnesium silicon, aluminum magnesium, aluminum magnesium iron, silver copper, cadmium copper or the like; the composite metal includes steel-cored aluminum, silver composite aluminum, aluminum composite iron or the like.

Further, the non-conducting material refers to non-metallic oxide related to the above-described metallic material, for example, if the first material is metal aluminum (Al) or aluminum alloy, the second material can be aluminum oxide (Al2O3).

In a procedure of actual implementation, a material of the partial portion of the housing obtained by transforming the partial portion of the housing is changed from the first material to the second material; wherein, the housing is wholly made of the first material and having the first shape.

It can be considered that the housing is a metallic housing made of the first material and having the first shape matched with a shape of the main body of the electronic apparatus. For example, the housing is a metallic housing made by the shaping processing of a plate stamping, a compression casting or a metal injecting or the like. The material of the partial portion is transformed from the first material to the second material after transforming the first material of the partial portion in the housing, so as to form the second portion 12 of the housing, and other portion that does not transformed is the first portion 11 of the housing, that is, the housing having the metallic material and the metal oxide material is obtained by partially transforming the housing which is wholly the metallic material, and integrality of the housing is ensured.

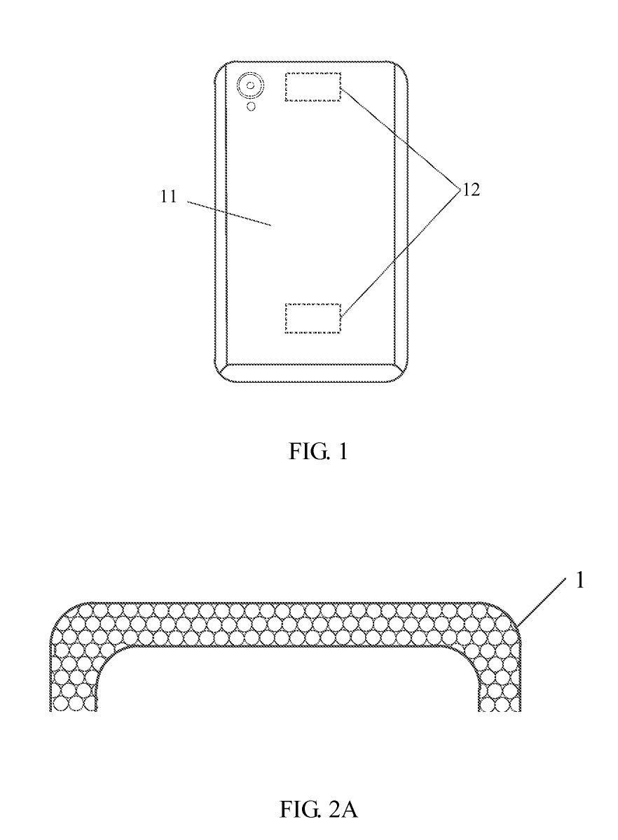

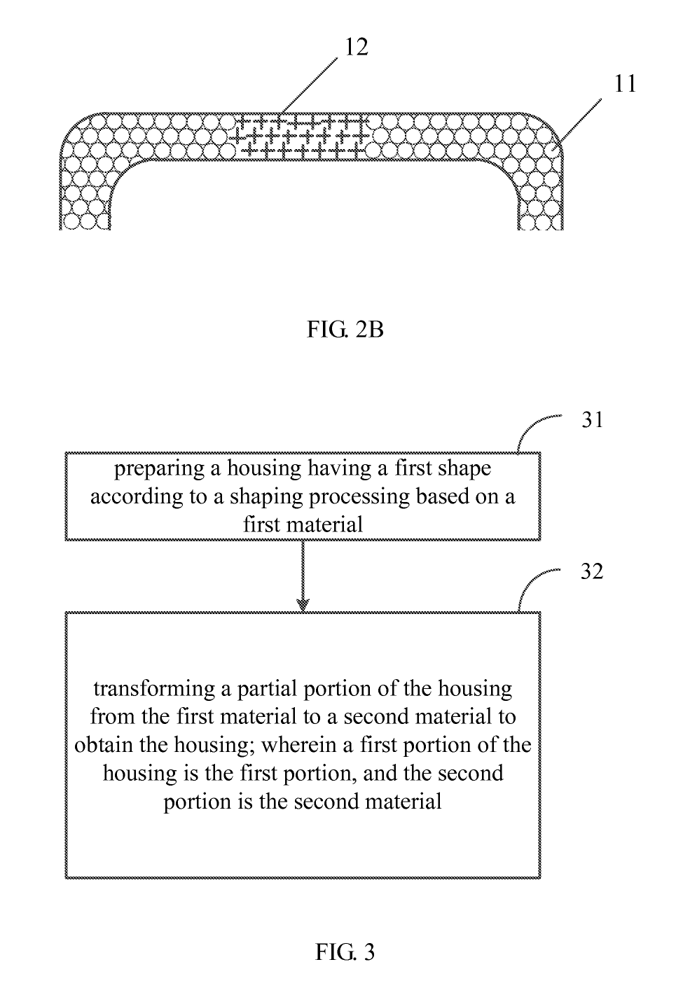

With reference to FIG. 2A, it is a cross section diagram of the housing, and a small circle “∘” in the diagram represents a schematic diagram of material constitution corresponding to the first material, for example, the small circle represents metal atom. At this time, the material of the housing is only the first material, i.e., a portion indicated by number 1, and the first material can be metal.

With reference to FIG. 2B, it is a cross section diagram of the housing, wherein, a portion of small circle still represents the first material, and a region having symbol “+” represents a region in which the first material is transformed to the second material through a transforming processing, that is, “+” represents the transformed second material, and a position of “+” in the housing is the second portion 12, and a region corresponding to the symbol “∘” is the first portion 11.

In the embodiments, the second portion allows a higher throughput rate of an electromagnetic wave to pass through than the first portion. That is, a throughput rate of electromagnetic wave corresponding to the second portion 112 is a first throughput rate, and a throughput rate of electromagnetic wave corresponding to the first portion 11 is a second throughput rate, and the second throughput rate is larger than the first throughput rate.

Since the electronic apparatus generally implement transmission of the wireless signal by manners of the electromagnetic wave such as GSM (Global System For Mobile Communications), CDMA (Code Division Multiple Access), 3G (3rd-Generation), GPS (Global Positioning System), Wi-Fi (Wireless-Fidelity), Blue-tooth or the like. When the electromagnetic wave transmits to a portion of the housing of the apparatus, degree of influence of the housing of the apparatus to the electromagnetic wave can be determined according to magnitude of the throughput rate of the electromagnetic wave of the housing. Generally, the higher the throughput rate of the electromagnetic wave in corresponding passing region in the housing is, the smaller the shielding effect to the electromagnetic wave thereof is, which is advantageous for the transmission of the wireless signal, and at this time, the material of the housing can be the non-metal material having higher throughput rate of the electromagnetic wave.

Optionally, in the embodiments, the electronic apparatus further comprising an antenna arranged with respect to the second portion of the housing. For example, the electronic apparatus further includes: M electronic elements provided in the housing, wherein M is a positive integer that larger than or equal to 1; wherein, the M electronic elements includes an antenna elements positioned in a region corresponding to the second portion 12 in the housing.

In a procedure of practical application, the electronic apparatus can be the main body constituting the electronic apparatus and communicates with the server or other electronic apparatus through the M electronic elements. The antenna element can be a signal projector, and the wireless signal transmitted thereof transmits to air rapidly through the second portion 12 having a larger throughput rate.

Thus, at the time of determining the partial portion that needs to be processed in the housing, it can be determined according to the position of the antenna element in the main body. For example, if the electronic apparatus is a mobile phone, a signal transmitting region corresponding to the antenna element may be at top and/or bottom of the mobile phone generally, and a first housing part corresponding to a top portion of the mobile phone and a second housing part corresponding to a bottom portion can be as the partial portion, so as to transform the first material corresponding thereto to the second material.

In the embodiments of this disclosure, since the housing of the electronic apparatus includes the first portion and the second portion, and the second material corresponding to the second portion is transformed from the first material corresponding to the first portion, the housing is made to be able to have two kinds of different and correlated materials at the same time of keeping integration of structure to make an overall strength well, so as to improve the throughput rate of the wireless signal. For example, when the first material is the metal, the second material may be the non-metal material obtained by transforming the metal, so that there is no need to punch or crop the housing, thus, at the time of using the electronic apparatus to transmit the wireless signal, the electromagnetic wave can transmit through the second portion well, so as to reduce a shield influence of the housing to the wireless signal and improves efficiency of transmission of signal of the electronic apparatus.

At the same time, since the first portion and the second portion are an integrated structure, a junction region is integrated, there is no need to execute further processing, which simplifies a producing procedure of the housing and reduces cost.

Since in the embodiments, the housing is made to have two different kinds of materials directly by the transforming processing of the material without splice or mosaic of the different materials, it eliminates reduction of intensity of the housing, so as to make the overall strength of the housing being hardly influenced in structure, and solve shield and attenuation of the metallic housing to the transmission signal of the electronic apparatus at the same time, so that conductive transmission of the signal can satisfy a national standard and an international standard.

At the same time, since there does not generate trace of junction or splice, there is no need of an eliminating processing, which makes production of the housing to be simpler and the flow to be easier to be implemented, and also implements possibility of application of the non-metallic housing on the electronic apparatus, which enriches selection of the material of the housing of the electronic apparatus.

Next, with reference to FIG. 3, based on a same concept, the embodiments further provide a method of making an electronic apparatus, the method including: forming a housing of the electronic apparatus using a first material; and transforming a portion of the housing from the first material into a second material.

With reference to FIG. 3, the method of making an electronic apparatus includes the following steps:

Step 31: producing a housing having a first shape according to a shaping processing based on a first material.

Wherein, the first material can be a metallic material or an alloy material, for example, metal aluminum or magnesium aluminum alloy, and overall material corresponding to the housing produced is the first material.

The shaping processing can include processing manners of plate stamping, compression casting or metal injecting or the like, this procedure is same as a procedure of producing a metallic housing, and it is no longer described. And the first shape can be a shape matched with the portion of the main body of the electronic apparatus and designed according to requirement of production. For example, the housing produced is made to have the first shape by using specific stamping mold.

For example, if a size of the electronic apparatus is 4.3 inch, and a thickness thereof is 0.6 mm, at the time of producing the housing of the mobile phone using metal (primarily a housing at the back side), the metallic housing produced is made to be able to conform to the size of the electronic apparatus by injecting the metal into corresponding mold, so as to facilitate a tight coupling there between.

Step 32: transforming the first material of a partial portion of the housing to a second material to obtain a housing; wherein a first portion of the housing is the first portion 11 made of the first material, and the partial portion is the second portion 12 made of the second material of the housing.

In the embodiments, after producing the housing, the partial portion can be determined according to a correspondence relationship between the housing and the electronic apparatus. For example, the electronic apparatus can include at least one signal transmitting source corresponding to the antenna element in the electronic apparatus, and corresponding passing regions in the housing of respective signal transmitting sources can be determined according to requirements of transmission of the wireless signal, then these passing regions can be determined as the partial portion.

For example, if the electronic apparatus is a notebook computer which includes a first signal transmitting source positioned at bottom of body and a second signal transmitting source positioned at side of the body, a first region corresponding to the first signal transmitting source and a second region corresponding to the second signal transmitting source in the housing can be determined as the partial region to carry out further processing.

In the embodiments, since in a procedure of transmitting the wireless signal of the electronic apparatus, it conducts mainly through the electromagnetic wave, when the housing is the metallic housing, if emitted electromagnetic wave arrives at an inner surface of the metallic housing, the metallic housing would reflect incident wave due to discontinuity of resistance on an interface between air and metal; and, energy that is not reflected by the inner surface and enters into the metallic housing destroys formation of an electric field to make the electric field to disappear due to a short circuit action of electro-conductive metal in a procedure of propagating forwards in the metallic housing, so that a magnetic field can't generated continuously to intercept a continue propagation of the electromagnetic wave, and the electromagnetic wave is attenuated by the metallic material, i.e., a so-called absorption, and remaining energy that is not attenuated in a shielding body propagates another surface of the material and meets an interface of discontinuous resistance between metal and air, and forms once more reflection and returns into the shielding body again. Such reflection may have multiple times of reflections on an interface of the two metals, so as to cause a relatively severe electromagnetic attenuation, therefore, in order to ensure communication quality, a transmitting power required for the electronic apparatus is relatively large.

However, due to the national standard and the international standard based on limitations of radiation of product and conductive transmission, there prescribes a minimum sensitivity requirement of various kinds of interference. Generally, there are different standards for different types of electronic apparatus, wherein, there requires that the transmitting power of the mobile phone and interference to other radio apparatus to be as small as possible in case of ensuring a normal communication in protocols such as GSM, CDMA or the like, so as to create a good wireless environment for other radio apparatus.

For example, the GSM protocol prescribes that the transmitting power of the mobile phone should be controllable by a base station. The base station issues commands to control levels of the transmitting power of the mobile phone through a downstream SACCH channel, and a difference between each level of power is 2 dB, a maximum level of the transmitting power of the mobile phone in GSM900 is 5 (33 dBm), and a minimum level of the transmitting power thereof is 19 (5 dBm), a maximum level of the transmitting power of the mobile phone in DCS 1800 is 0 (30 dBm), and a minimum level of the transmitting power thereof is 15 (0 dBm), thus, in a procedure of producing electronic products, it is necessary to satisfy these standards. Therefore, in the embodiments, after determining the partial region, in order to reduce a shielding effect of the metallic housing to the electromagnetic wave and ensure the electronic apparatus to transmit the wireless signal normally, the partial portion is executed a transforming processing. In a procedure of actual implementation, the transforming processing can be any one of a physical processing manner, a chemical processing manner or an electric processing manner or a combined processing manner thereof, to transform the first material of the partial portion to the second material, wherein, the second material can be non-conductive compound, for example metal oxide.

In the embodiments, the transforming of the portion of the housing from the first material into the second material includes: electrochemically transforming the portion of the housing using an acid solution. That is, transforming the first material of the partial portion of the housing to a second material to obtain a housing is specifically: executing an electrochemical transforming processing to the first material of the partial portion in the housing by a first strongly acid solution; obtaining the housing of which a material of the partial portion is the second material changed from the first material, and a material of the first portion 11 in the housing is first metal, and a material of the second portion 12 is metal oxide corresponding to the first metal.

Wherein, the first strongly acid solution can be acidic solutions that can react with the first material to generate the non-metallic second material such as high manganese acid, sulfuric acid, nitric acid or the like.

Optionally, in the embodiments, the method further includes: isolating a region of the housing not corresponding to the portion of the housing using a first protective film to prevent the region of the housing from transforming from the first material into the second material. And, the isolating of the region of the housing comprises spraying an isolation ink on a surface of the region of the housing.

In particular, before executing the transforming processing to the housing, the method can further include: executing an isolating processing to a region corresponding to the portion other than the partial portion in the housing, so that a surface of the region corresponding to the portion other than the partial portion in the housing is covered with a first protective film; wherein, the first protective film is able to prevent the portion to contact with outside.

At the time of executing the transforming processing to the partial portion, it is specifically divided into the following steps:

(1) Executing a preliminary processing to the housing;

Clearing oily soil and oxide layer on the surface of the housing to activate the surface thereof, and putting the housing in a shaken grinder to grind to clear off surface defects such as surface oxide, burr, scuffing or the like, then, putting the housing in a ultrasonic cleaner to clear oil by a de-oil agent of which concentration is 1%-20% and temperature is a room temperature of 10-50 and soaking time is 6-30 minutes, and then washing clean by de-ion water, and drying in a 120 drying box.

(2) Isolating processing:

After determining the partial portion, shielding a portion of the housing that needs not to be transformed in material by using a spraying method to spray an isolation ink on a surface corresponding to the portion other than the partial portion in the housing to execute the isolating processing, wherein the ink used can be a shielding ink against high-temperature electro-chemical corrosion.

(3) Modifying a material of the partial portion by using electrochemistry:

Putting the housing subjected to step (2) in a sulfuric acid solution (or a mixed solution of different acid) to executing a electrochemistry partial modifying processing with a specimen as an anode and a corrosion resistant plate as a cathode, wherein, volumetric concentration of the sulfuric acid solution is 10-900 ml/L (that is, a sulfuric acid of 98%), current density passing through the solution is 0.1-50 A/dm2, processed time is 5-120 minutes, thickness of transformation of inside and outside surfaces can reach 2-3 millimeters, and washing with water and drying after finishing the processing.

(4) Clearing the shielding ink:

Executing cleaning processing to obtained the housing by using an ink detergent to obtain electrochemistry modification of the partial material in an antenna region ultimately, that is, the material of the partial portion changes from the first material to the second material to constitute the second portion 12 of the housing, and if the first material is an aluminum alloy, the transformed material is ceramic material of which main component is aluminum oxide.

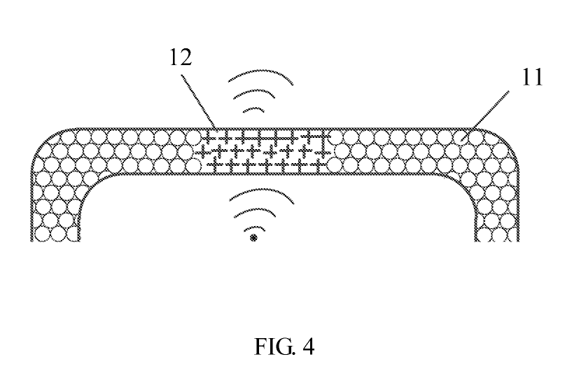

With reference to FIG. 4, it represents a passing through condition of electromagnetic signal after the transforming processing, that is, the throughput rate of the second portion is relatively high and has little shielding effect to the signal.

In the embodiments, since the partial portion is processed by using an electrochemical transforming manner, a transitional region generated in the housing would not influence integrality of structure of the housing, and, in order for the processed housing to satisfy a standard for passing through the electromagnetic signal, at the time of determining the partial processing, the transitional region can be calculated out of the partial region according to used processing manner and result, so as to make the partial portion obtained by executing the transforming processing to be able to satisfy the standard for passing through the electromagnetic signal, that is, by the processing of the housing, it implements a relatively good transmission effect at the same time of using the metallic housing of the electronic apparatus.

The embodiments disclose an electronic apparatus at least including: a housing including a first portion 11 made of a first material and a second portion 12 made of a second material, and the second material is a material formed by executing a transforming processing to the first material.

In the embodiments, since the housing of the electronic apparatus includes the first portion 11 and the second portion 12, and the second material corresponding to the second portion 12 is transformed from the first material corresponding to the first portion 11, the housing is made to be able to have two kinds of different and correlated materials at the same time of keeping integration of structure to make an overall strength well, so as to improve the throughout rate of the wireless signal. For example, when the first material is the metal, the second material may be the non-metal material obtained by transforming the metal, so that there is no need to punch or crop the housing, thus, at the time of using the electronic apparatus to transmit the wireless signal, the electromagnetic wave can transmit through the second portion 12 well, so as to reduce a shield influence of the housing to the wireless signal and improves efficiency of transmission of signal of the electronic apparatus.

At the same time, since the first portion 11 and the second portion 12 are an integrated structure and a junction region is intact without any further processing, it simplifies a producing procedure of the housing and reduces cost at the same time.

Those skilled in the art can understand that, for the convenience and simplicity of the description, it takes the above division of the respective functional modules as example, in the practical application, the above-described functions can be assigned to different functional modules to be performed as necessary, that is, the internal structure of the device can be divided into different functional modules to perform all or a part of the above-described functions. The specific operational procedure of the above-described system, device and units can refer the corresponding procedure in the above embodiment of method, and are no longer described.

In the several embodiments provided by this disclosure, it is understood that the disclosed system, device and method can be implemented by other means. For example, the above-described embodiments of the apparatus are only schematic, for example, the division of the modules or the units is only a logical functional division, and there can be other manners of division in the actual implementation, for example, a plurality of units or components can be combined or integrated into another system, or some features can be neglected or are not implemented. In another point, coupling or direct coupling or communication connection between the respective constituent parts shown or discussed may be indirect coupling or communication connection through some interfaces, devices or units, and may be electrical, mechanical or other forms.

The units explained as separate components may be, or may not be separated physically, and the components shown as units may be or may not be physical units, that is, they may be positioned at one location, or may also be distributed to a plurality of network units. Object of the solutions of the embodiments can be implemented by selecting some or all of the units according to actual requirement.

Further, all of the respective functional units in the respective embodiments of this disclosure may be integrated into one processing unit, or the respective units may be as a separate unit respectively, or two or more units may be integrated into one unit. The above-described integrated unit can be implemented by form of hardware, or may be implemented by form of software functional unit.

If the above-described integrated units are implemented in form of software functional modules and sold or used as independent product, it may also be stored in one computer readable storage medium. Based on such understanding, the technical solutions of this disclosure essentially or the part contributed to the related art can be embodied by a form of a software product, the computer software product is stored in a storage medium, which includes some instructions to cause a computer equipment (which may be a personal computer, a server or a network equipment or the like) or a processor to execute all or a part of the steps of the method in the respective embodiments of this disclosure. And the aforementioned storage medium includes various media which can store program code such as a USB disc, a mobile hard disk, a read-only memory (ROM), a random access memory (RAM), a magnetic disc or an optical disk.

The above described embodiments only explain the technical solutions of this disclosure detailed, and the explanation of the above described embodiments is only for understanding the method of this disclosure and a kernel idea thereof, and it should not be understood as limitation to this disclosure. Any modification or replacement thought of by those skilled in the art easily in scope of disclosed techniques of this disclosure should fall into a scope sought for protection by this disclosure. It is obvious that those skilled in the art can make various kinds of modification and variation to this disclosure without departing from the spirit and scope of this disclosure. Thus, if these modifications and variations of this disclosure fall into the scope of the claims of this disclosure and the equivalent technology, this disclosure intends to comprise these modifications and variations.

1. An electronic apparatus, comprising a housing comprising a first portion and a second portion, the first portion being made of a first material and the second portion being made of a second material which is transformed from the first material.

2. The electronic apparatus according to claim 1, wherein the housing is made of the first material and the second material.

3. The electronic apparatus according to claim 1, wherein the second portion allows a higher throughput rate of an electromagnetic wave to pass through than the first portion.

4. The electronic apparatus according to claim 1, further comprising an antenna arranged with respect to the second portion of the housing.

5. The electronic apparatus according to claim 1, wherein the first material is a conductive material and the second material is a non-conductive material, and the second material is transformed from the first material through any one of a physical process, a chemical process, an electric process, or a combined process thereof.

6. The electronic apparatus according to claim 5, wherein the conductive material is a metal and the non-conductive material is a metal oxide.

7. A method of making an electronic apparatus, the method comprising forming a housing of the electronic apparatus using a first material and transforming a portion of the housing from the first material into a second material.

8. The method according to claim 7, wherein the forming of the housing comprises a plate stamping, a compression casting or a metal injecting of the first material.

9. The method according to claim 8, wherein the transforming of the portion of the housing from the first material into the second material comprises electrochemically transforming the portion of the housing using an acid solution.

10. The method according to claim 8, further comprising isolating a region of the housing not corresponding to the portion of the housing using a first protective film to prevent the region of the housing from transforming from the first material into the second material.

11. The method according to claim 10, wherein the isolating of the region of the housing comprises spraying an isolation ink on a surface of the region of the housing.
